(19) United States
(12) Patent Application Publication
(10) Pub. No.: US 2022/0117433 A1
(43) Pub. Date: Apr. 21, 2022

(54) COOKING UTENSIL

(71) Applicant: ZHONGSHAN GAOTONG ELECTRIC CO., LTD., Zhongshan (CN)

(72) Inventors: Shuang WANG, Zhongshan (CN); Daxing CHEN, Zhongshan (CN)

(21) Appl. No.: 17/646,298

(22) Filed: Dec. 29, 2021

Related U.S. Application Data
(63) Continuation of application No. PCT/CN2020/108029, filed on Aug. 8, 2020.

(30) Foreign Application Priority Data
Nov. 19, 2019 (CN) 201911131241.9

(51) Int. Cl. A47J 27/082; A47J 27/086; A47J 37/06; H05B 3/26; F04D 17/16; F04D 19/00; F04D 25/16; F04D 29/44

(52) U.S. Cl. CPC A47J 27/082; A47J 27/086; A47J 37/0641; A47J 37/0664; F04D 25/06; F04D 17/16; F04D 19/002; F04D 25/166; F04D 29/441; H05B 3/26

(57) ABSTRACT

The present disclosure relates to a cooking utensil with air frying and pressure cooker functions. The cooking utensil includes a cooker body (1), an inner pot (2), a lid (4), and a heating plate (5); the cooker body (1) includes a middle housing (15) and an outer housing (23); the heating plate (5) is arranged above a bottom surface of the middle housing (15); the inner pot (2) is arranged in an inner cavity of the middle housing (15). When the air frying subassembly (3) is put into the cooker body, the fan subassembly works, and the centrifugal air turbine (12) draws air in the cavity of the middle housing (15) into the bottom surface of the middle housing (15) and exchanges heat with the heating plate (5) to cook food.

### CROSS REFERENCE TO RELATED APPLICATIONS

The present application is a Continuation Application of PCT Application No. PCT/CN2021/108029 filed on Aug. 8, 2020, which claims the benefit of Chinese Patent Application No. 201911131241.9 filed on Nov. 19, 2019. All the above are hereby incorporated by reference. the contents of which are incorporated herein by reference in their entirety.

### TECHNICAL FIELD

The present disclosure relates to a cooking utensil with air frying and pressure cooker functions.

### BACKGROUND ART

There is a food cooking utensil with air frying and pressure cooker functions. The food cooking utensil is equipped with two lids, one of which is an ordinary pressure cooker lid. The lid and a cooker body are closed to form a pressure cooker. The other one is an air fryer lid. A heating device and an air supply device are arranged in the lid. The air fryer lid is covered on the cooker body to form an air fryer apparatus. This structure has high cost since it needs to be equipped with two lids. To use the air fryer lid, electricity must be applied, and so does the cooker body. Therefore, an electric coupler is also set up between the air fryer lid and the cooker body.

### SUMMARY

Therefore, the present disclosure provides a cooking utensil which has an air frying and pressure cooker two-in-one function and can realize air frying and pressure cooker functions by one lid.

The purpose of the present disclosure is realized by a real sample.

A cooking utensil includes a cooker body, an inner pot, a lid, and a heating plate; the cooker body includes a middle housing and an outer housing; the heating plate is arranged above a bottom surface of the middle housing; the inner pot is arranged in an inner cavity of the middle housing; the cooking utensil further includes an air frying subassembly, the inner pot is removed from the inner cavity of the middle housing, and the air frying subassembly is put into the inner cavity; the air frying subassembly is disposed upright above the heating plate; a fan subassembly is arranged at a bottom of the cooker body; and the fan subassembly blows heat generated by the heating plate to an inner cavity of the air frying subassembly.

The above-mentioned technical solution can be further perfected as follows.

A through hole is formed in the middle of the heating plate; a hollow vertical column is arranged at a bottom of the air frying subassembly; the vertical column is connected with the through hole; a side wall of the vertical column is provided with an air hole; and the air hole is communicated with the inner cavity of the air frying subassembly.

The fan subassembly includes a hot air fan, a motor, and a cooling fan from top to bottom; the motor drives the hot air fan and the cooling fan to rotate; the hot air fan is arranged below the through hole and is located above the bottom surface of the middle housing; a first air channel is formed between the hot air fan and the hollow vertical column; and the motor and the cooling fan are arranged between the bottom surface of the middle housing and a bottom surface of the outer housing.

A second air channel is arranged between the heating plate and the bottom surface of the middle housing, and the hot air fan is communicated with the first air channel and the second air channel.

A third air channel is arranged between the air frying subassembly and the middle housing, and the third air channel is communicated with the second air channel.

An upper side wall of the air frying subassembly is provided with an air intake hole, ensuring that the inner cavity of the air frying subassembly is communicated with the third air channel and the inner cavity of the air frying subassembly is communicated with the first air channel through the air hole.

The side wall of the vertical column is further provided with a lampblack filter net.

The hot air fan is a centrifugal wind turbine; a rotating shaft of the motor upwards passes through the bottom surface of the middle housing to drive the centrifugal wind turbine; an air inlet of the centrifugal wind turbine is communicated with the hollow vertical column; an air outlet of the centrifugal wind turbine is communicated with the second air channel; and a bottom surface of the heating plate is provided with a heat dissipation sheet.

A side wall of the cooker body is provided with a heat dissipation hole, and the heat dissipation hole penetrates through an inner cavity and an outer cavity of the cooker body.

A bottom surface of the outer housing is provided with a heat dissipation air hole; a cold air inlet is arranged above a side surface of the outer housing; the cooling fan rotates under the driving of the motor to draw cold air from the cold air inlet; and the cold air flows in a cavity between the middle housing and the outer housing and is blown out from the heat dissipation air hole.

In the present disclosure, the bottom of the cooker body is improved: the fan subassembly is additionally arranged below the heating plate. When the inner pot is put into the cooker body, the lid is closed, and this cooking utensil is an ordinary electric pressure cooker. At this time, the fan subassembly does not work. When the inner pot is removed, and the air frying subassembly is put into the cooker body, the centrifugal air turbine draws the air in the cavity of the middle housing into the bottom surface of the middle housing and exchanges heat with the heating plate; the air that absorbs heat is sprayed out from a gap between the bottom surface of the heating plate and the bottom surface of the middle housing and rises up between an outer wall of the air frying subassembly and an inner wall of the middle housing to enter the air frying subassembly to cook food; and hot air is finally drawn from the vertical column into the centrifugal air turbine for next cycle.

### BRIEF DESCRIPTION OF THE DRAWINGS

FIG. 1 is a schematic exploded diagram of an embodiment.

FIG. 2 is a structural sectional diagram of use of an air frying subassembly of an embodiment.

FIG. 3 is a structural exploded diagram of use of an air frying subassembly of an embodiment.

FIG. 4 is a schematic diagram of a sectional structure when an inner pot is used in an embodiment.

### DETAILED DESCRIPTION OF THE EMBODIMENTS

The present disclosure is further described below in detail in combination with the accompanying drawings and embodiment.

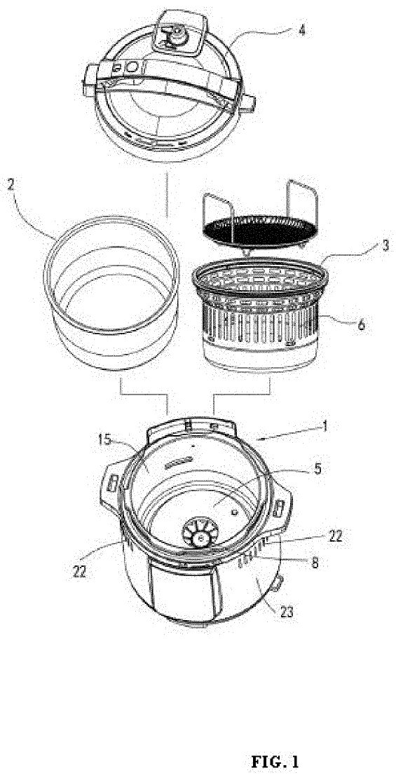

In an embodiment, referring to the figures, as shown in FIG. 1, a cooking utensil includes a cooker body 1, an inner pot 2, an air frying subassembly 3, a lid 4, and a heating plate 5; the cooker body includes a middle housing 15 and an outer housing 23; the heating plate 5 is arranged above a bottom surface of the middle housing 15; and the inner pot 2 is arranged in an inner cavity of the middle housing 15 to form a pressure cooker. The inner pot 2 is removed from the cavity of the middle housing 15, and the air frying subassembly 3 is put into the cavity of the middle housing 15 to form an air fryer appliance.

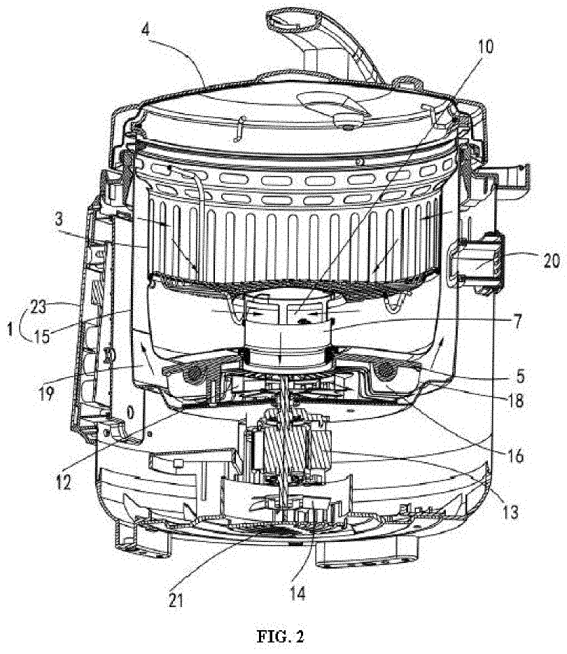

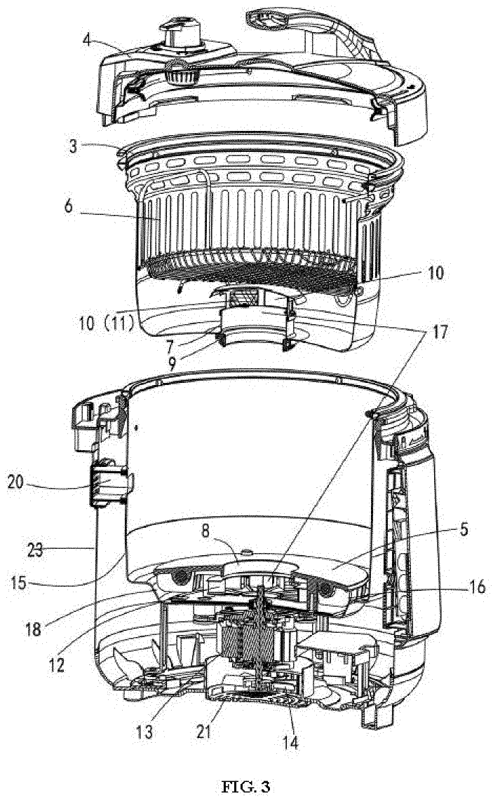

As shown in FIG. 2 and FIG. 3, the air frying subassembly 3 is disposed upright above the heating plate 5, and a hollow vertical column 7 is arranged at a bottom of the air frying subassembly. The air frying subassembly 3 is put into the cooker body 1 and is covered with the lid 4; and the lid 4 and a top port of the air frying subassembly 3 are sealed. Of course, the air frying subassembly 3 and the lid 4 may not be in sealing fit.

A through hole 8 is formed in the middle of the heating plate 5; the vertical column 7 is inserted into the through hole 8; a sealing ring 9 is arranged between the vertical column 7 and the through hole 8; a side wall of the vertical column 7 is provided with an air hole 10 and is further provided with a lampblack filter net 11; and the lampblack filter net 11 is covered on a surface of the air hole 10.

A fan subassembly is arranged at a bottom of the cooker body 1, and includes a centrifugal air turbine 12, a motor 13, and a cooling fan 14 from top to bottom; and the motor 13 drives the centrifugal air turbine 12 and the cooling fan 14 to rotate.

The middle housing 15 is formed into an inner surface of the cooker body 1, and the heating plate 5 is arranged above the bottom surface of the middle housing 15; and bottom surface of the heating plate 5 is provided with a heat dissipation sheet 16.

The centrifugal air turbine 12 is arranged below the heating plate 5 and is located above the bottom surface of the middle housing 15. A rotating shaft of the motor 13 upwards passes through the bottom surface of the middle housing 15 to drive the centrifugal air turbine 12.

The centrifugal air turbine 12 is arranged below the through hole 8, and an air inlet of the centrifugal air turbine 12 is communicated with the hollow vertical column 7 to form a first air channel 17. A second air channel 18 is formed in a gap between the heating plate 5 and the bottom surface of the middle housing 15; an air outlet of the centrifugal air turbine 12 is formed in a radial direction of the centrifugal air turbine 12 and is communicated with a second air channel 18; a third air channel 19 is arranged between an outer wall of the air frying subassembly 3 and the middle housing 15; and the third air channel 19 is communicated with the second air channel 18.

An upper side wall of the air frying subassembly 3 is provided with an air intake hole 6, so that the inner cavity of the air frying subassembly 3 is communicated with the third air channel 19 and the inner cavity of the air frying subassembly 3 is communicated with the first air channel 17 through the air hole 10.

The above-mentioned hot air path is simply described again. Referring to the direction shown by the arrow, the heating plate 5 generates heat; under the action of the centrifugal air turbine 12, air in the air frying subassembly 3 enters the vertical column 7 via the air hole 10 from the bottom surface of the air frying subassembly 3, and downwards enters the centrifugal air turbine 12 along the first air channel 17; the centrifugal air turbine 12 throws out the air, and the thrown air absorbs the heat of the heating plate 5, enters the third air channel 19 from the second air channel 18, and enters the air frying subassembly 3 to cook food from the air intake hole 6 in the side wall of the air frying subassembly 3; and after releasing the heat, the hot air enters the first air channel 17 again for next cycle.

A side wall of the cooker body 1 is provided with a heat dissipation hole 20, and the heat dissipation hole 20 penetrates through the middle housing 15 and the outer housing 23. When the air frying subassembly 3 is used, the heat dissipation hole 20 may dissipate part of the heat in the cooker body 1 to prevent an extremely high temperature in the cooker body 1.

A bottom surface of the outer housing 23 is provided with a heat dissipation air hole 21; a cold air inlet 22 is arranged above a side wall of the outer housing 23; the cooling fan 14 rotates under the driving of the motor 13 to draw cold air from the cold air inlet 22; and the cold air flows in a cavity between the middle housing 15 and the outer housing 23 and is blown out from the heat dissipation air hole 21.

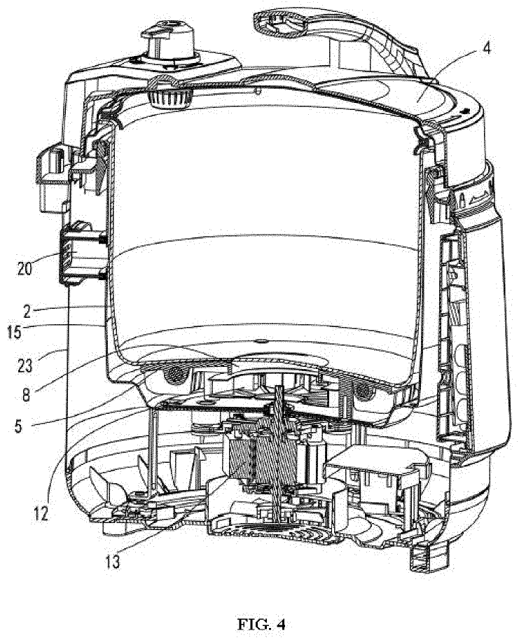

As shown in FIG. 4, this product is an ordinary pressure cooker. The air frying subassembly 3 is removed from the cooker body 1, and the inner pot 2 is directly put into the cooker body 1; the lid 4 is closed; and the inner pot 2 can cover the through hole 8 in the middle of the heating plate 5 and the heat dissipation hole 20 in the side wall of the cooker body 1.

What is claimed is:

1. A cooking utensil, comprising a cooker body (1), an inner pot (2), a lid (4), and a heating plate (5), wherein the cooker body (1) comprises a middle housing (15) and an outer housing (23); the heating plate (5) is arranged above a bottom surface of the middle housing (15); the inner pot (2) is arranged in an inner cavity of the middle housing (15); the cooking utensil is characterized by further comprising an air frying subassembly (3); when the inner pot (2) is removed from the inner cavity of the middle housing (15), and the air frying subassembly (3) is put into the inner cavity, the air frying subassembly (3) is disposed upright above the heating plate (5); a fan subassembly is arranged at a bottom of the cooker body (1); and the fan subassembly blows heat generated by the heating plate (5) to an inner cavity of the air frying subassembly (3).

2. The cooking utensil according to claim 1, wherein a through hole (8) is formed in the middle of the heating plate (5); a hollow vertical column (7) is arranged at a bottom of the air frying subassembly (3); the vertical column (7) is connected with the through hole (8); a side wall of the vertical column (7) is provided with an air hole (10); and the air hole (10) is communicated with the inner cavity of the air frying subassembly (3).

3. The cooking utensil according to claim 2, wherein the fan subassembly comprises a hot air fan, a motor (13), and a cooling fan (14) from top to bottom; the motor (13) drives the hot air fan and the cooling fan (14) to rotate; the hot air fan is arranged below the through hole (8) and is located above the bottom surface of the middle housing (15); a first air channel (17) is formed between the hot air fan and the hollow vertical column (7); and the motor (13) and the cooling fan (14) are arranged between the bottom surface of the middle housing (15) and a bottom surface of the outer housing (23).

4. The cooking utensil according to claim 3, wherein a second air channel (18) is arranged between the heating plate (5) and the bottom surface of the middle housing (15), and the hot air fan is communicated with the first air channel (17) and the second air channel (18).

5. The cooking utensil according to claim 4, wherein a third air channel (19) is arranged between the air frying subassembly (3) and the middle housing (15), and the third air channel (19) is communicated with the second air channel (18).

6. The cooking utensil according to claim 5, wherein an upper side wall of the air frying subassembly (3) is provided with an air intake hole (6), ensuring that the inner cavity of the air frying subassembly (3) is communicated with the third air channel (19) and the inner cavity of the air frying subassembly (3) is communicated with the first air channel (17) through the air hole (10).

7. The cooking utensil according to claim 2, wherein the side wall of the vertical column (7) is further provided with a lampblack filter net (11).

8. The cooking utensil according to claim 4, wherein the hot air fan is a centrifugal wind turbine (12); a rotating shaft of the motor (13) upwards passes through the bottom surface of the middle housing (15) to drive the centrifugal wind turbine (12); an air inlet of the centrifugal wind turbine (12) is communicated with the hollow vertical column (7); an air outlet of the centrifugal wind turbine (12) is communicated with the second air channel (18); and a bottom surface of the heating plate (5) is provided with a heat dissipation sheet (16).

9. The cooking utensil according to claim 1, wherein a side wall of the cooker body (1) is provided with a heat dissipation hole (20), and the heat dissipation hole (20) penetrates through an inner cavity and an outer cavity of the cooker body (1).

10. The cooking utensil according to claim 3, wherein a bottom surface of the outer housing (23) is provided with a heat dissipation air hole (21); a cold air inlet (22) is arranged above a side surface of the outer housing (23); the cooling fan (14) rotates under the driving of the motor (13) to draw cold air from the cold air inlet (22); and the cold air flows in a cavity between the middle housing (15) and the outer housing (23) and is blown out from the heat dissipation air hole (21).
